(19) United States
(12) Patent Application Publication
(10) Pub. No.: US 2017/0225275 A1
(43) Pub. Date: Aug. 10, 2017

(54) DEVICE AND METHOD FOR MEASURING QUALITY OF ULTRASONIC WELDING

(71) Applicant: MONITECH CO.,LTD., Busan (KR)

(72) Inventors: Dong Soo HWANG, Busan (KR); Hui Jun LEE, Seoul (KR)

(73) Assignee: MONITECH CO.,LTD., Busan (KR)

(21) Appl. No.: 15/373,781

(22) Filed: Dec. 9, 2016

(30) Foreign Application Priority Data
Feb. 5, 2016 (KR) 10-2016-0014841

(51) Int. Cl. B23K 31/12; B23K 20/10

(52) U.S. Cl. CPC B23K 31/125; B23K 20/10

(57) ABSTRACT

Disclosed are a device and a method for measuring welding quality. The device for measuring welding quality according to one aspect of the present disclosure includes: a sensor unit which provides sensor transmission information; and a welding quality measuring unit which obtains welder output energy, obtains sensor transmission energy by using the sensor transmission information, calculates welding absorbing energy, and determines whether a welding defect occurs by using the welding absorbing energy.

### CROSS-REFERENCE TO RELATED APPLICATIONS

This application claims benefit and priority to Korean Patent Application No. 10-2016-0014841 filed on Feb. 5, 2016 with the Korean Intellectual Property Office, the disclosure of which is incorporated herein in its entirety by reference.

### TECHNICAL FIELD

The present disclosure relates to a device and a method for measuring quality of ultrasonic welding.

### BACKGROUND

In general, ultrasonic welding refers to a method of joining workpieces to be welded together by using ultrasonic vibration, by holding the workpieces between two welding tips under a low load condition and imparting ultrasonic waves while pressing the workpieces, and the ultrasonic welding is mainly used to weld mild steel, aluminum, plastic, or the like.

That is, in the ultrasonic welding, mechanical energy generated by ultrasonic oscillation at a frequency of approximately 10 to 80 kHz is applied to the workpieces to be welded. When sufficient energy is applied, the workpieces are locally heated, and as a result, the attachment is carried out by a movement of metal. This is a welding method in which there is no high-temperature fusion or no addition of third metal, which is carried out by a typical welding method.

Ultrasonic energy is applied by bringing a vibration welding head, which is called a horn, into contact with an attachment surface. The ultrasonic welding is performed in a state in which the horn is pressed, with sufficient force, against an upper surface of the workpiece to be welded.

A condition for obtaining optimum welding quality in the ultrasonic welding varies depending on a size, a shape, and a material of the workpiece to be welded, pressing pressure, oscillation time, amplitude of vibration of the horn, and the like, and as a result, optimum values are obtained through experiments and then used.

In addition, in order to manage welding quality in the ultrasonic welding, only a method of measuring energy applied to an exciter of an ultrasonic welding device and determining a welding defect when the measured energy exceeds a predetermined range is used in the related art.

However, the method of measuring welding quality in the related art is not used at present because reliability of the method is low.

### SUMMARY

The present disclosure has been made in an effort to provide a device and a method for measuring quality of ultrasonic welding which are excellent in reliability.

Other objects of the present disclosure may be more clearly understood from the following exemplary embodiments.

An exemplary embodiment of the present disclosure provides a device for measuring welding quality, the device including: a sensor unit which provides sensor transmission information; and a welding quality measuring unit which obtains welder output energy, obtains sensor transmission energy by using the sensor transmission information, calculates welding absorbing energy, and determines whether a welding defect occurs by using the welding absorbing energy.

The device for measuring welding quality according to the present disclosure may include one or more of the following exemplary embodiments. For example, the welding quality measuring unit may determine that welding is not performed when the welding absorbing energy is below a predetermined value, and may determine that welding is excessively performed when the welding absorbing energy is above a predetermined value.

At least one of an acceleration sensor, a laser displacement sensor, and an eddy current sensor, which are capable of measuring a movement of an anvil, may be used as the sensor unit.

The welding quality measuring unit may obtain the welder output energy by using electric current and voltage supplied to a controller or a vibrator of an ultrasonic welding system.

Another exemplary embodiment of the present disclosure provides a method for measuring quality of ultrasonic welding, the method including: measuring welder output energy and sensor transmission energy; calculating welding absorbing energy by using the welder output energy and the sensor transmission energy; and measuring welding quality by using the welding absorbing energy.

The method for measuring welding quality according to the present disclosure may further include the following exemplary embodiment. For example, when it is determined that a defect occurs based on the result of measuring the welding quality, at least one of pressing force, amplitude of vibration, time, and frequency is controlled so that welding quality becomes appropriate welding.

The present disclosure may provide the device and the method for measuring welding quality which have high reliability.

Further, the present disclosure may provide the device and the method for measuring welding quality which simplify a measuring method and obtain intuitive measurement results.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a view illustrating an ultrasonic welding system provided with a device for measuring quality of ultrasonic welding according to an exemplary embodiment of the present disclosure.

FIG. 2 is a flowchart illustrating a method for measuring quality of ultrasonic welding according to the exemplary embodiment of the present disclosure.

FIG. 3 is a graph illustrating welding quality with respect to energy absorbed by a welded portion.

### DETAILED DESCRIPTION

In the following detailed description, reference is made to the accompanying drawing, which forms a part hereof. The illustrative embodiments described in the detailed description, drawing, and claims are not meant to be limiting. Other embodiments may be utilized, and other changes may be made, without departing from the spirit or scope of the subject matter presented here.

The present disclosure may have various modifications and a variety of exemplary embodiments, and thus specific exemplary embodiments will be illustrated in the drawings and described in detail in the detailed description. However, it should be understood that the present disclosure is not limited to the specific exemplary embodiments, and includes all of modifications, equivalents, and substitutions included in the spirit and the technical scope of the present disclosure. In the description of the present disclosure, the specific descriptions of publicly known related technologies will be omitted when it is determined that the specific descriptions may obscure the subject matter of the present disclosure.

Terms used in the present application are used only to describe specific exemplary embodiments, and are not intended to limit the present disclosure. Singular expressions used herein include plurals expressions unless they have definitely opposite meanings in the context. In the present application, it will be appreciated that terms “including” and “having” are intended to designate the existence of characteristics, numbers, steps, operations, constituent elements, and components described in the specification or a combination thereof, and do not exclude a possibility of the existence or addition of one or more other characteristics, numbers, steps, operations, constituent elements, and components, or a combination thereof in advance.

The terms such as “first” and “second” may be used to describe various constituent elements, but the constituent elements should not be limited by the terms. These terms are used only to distinguish one constituent element from another constituent element.

Hereinafter, the exemplary embodiments according to the present disclosure will be described in detail with reference to the accompanying drawings, and in the description of the exemplary embodiments, the same or corresponding constituent elements will be designated by the same reference numerals regardless of reference numerals, and a duplicated description thereof will be omitted.

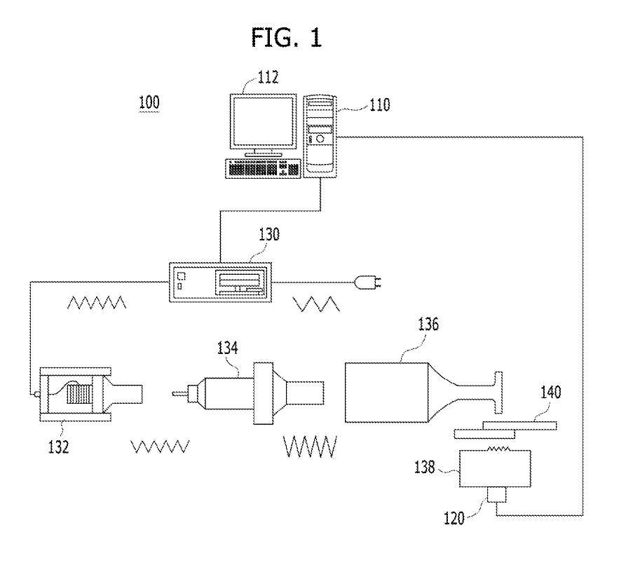

FIG. 1 is a view illustrating an ultrasonic welding system provided with a device 100 for measuring quality of ultrasonic welding according to an exemplary embodiment of the present disclosure.

The device 100 for measuring quality of ultrasonic welding according the present exemplary embodiment is provided in the ultrasonic welding system and may measure quality of ultrasonic welding in real time.

The device 100 for measuring quality of ultrasonic welding according to the present exemplary embodiment includes a sensor unit 120 which provides sensor transmission information, and a welding quality measuring unit 110 which obtains welder output energy Eo, obtains sensor transmission energy Et by using the sensor transmission information, calculates welding absorbing energy Ew, and then determines whether a welding defect occurs by using the welding absorbing energy Ew.

The ultrasonic welding system will be described prior to describing the device 100 for measuring quality of ultrasonic welding according to the present exemplary embodiment.

The ultrasonic welding system includes a controller 130, a vibrator 132, a booster 134, a horn 136, and an anvil 138.

The vibrator 132 generates vibration by electric power supplied from the controller 130. The horn 136 performs welding on an upper surface of a workpieces 140 to be welded by using vibration energy from the vibrator 132. The booster 134 is positioned between the horn 136 and the vibrator 132, decreases or increases amplitude of vibration from the vibrator 132, and then transmits the vibration to the horn 136. The controller 130 controls frequency and amplitude of vibration by controlling electric power supplied to the vibrator 132.

The horn 136 performs welding by vibrating in a horizontal direction by vibration energy from the vibrator 132 and pressing the workpieces 140 to be welded.

The anvil 138 supports the workpieces 140 to be welded, and the welding is performed as the workpieces 140 to be welded are pressed and vibrated between the horn 136 and the anvil 138. The sensor unit 120 may be coupled to the anvil 138.

The sensor unit 120 is coupled to the anvil 138, and provides the sensor transmission information for obtaining the sensor transmission energy Et to the welding quality measuring unit 110. The sensor unit 120 may be at least one or a combination of an acceleration sensor, a laser displacement sensor, and an eddy current sensor.

The acceleration sensor measures acceleration of the vibrating anvil 138 or intensity of impact. The sensor transmission information such as acceleration or impact transmitted to the anvil 138 is transmitted to the welding quality measuring unit 110. The welding quality measuring unit 110 may obtain the sensor transmission energy Et based on the following equation.

Et=½ mv

In the above equation, m is a sum of weights of the horn 136, the anvil 138, and the workpieces 140 to be welded. The welding quality measuring unit 110 may obtain a velocity v by integrating the acceleration value measured by the acceleration sensor, and then obtain the sensor transmission energy Et based on the above equation.

The acceleration sensor may be coupled to the anvil 138 by various means and methods. For example, the acceleration sensor may be mechanically coupled to a lateral side of the anvil 138 or may be coupled to the anvil 138 by other members (not illustrated). As described above, the present disclosure is not limited by a method of coupling the acceleration sensor to the anvil 138.

The acceleration sensor may be coupled to the horn 136, and may measure acceleration of the horn 136, thereby providing the sensor transmission information to the welding quality measuring unit 110.

The laser displacement sensor measures displacement of the anvil 138 which is caused by vibration, and provides the displacement of the anvil 138, as the sensor transmission information, to the welding quality measuring unit 110. The welding quality measuring unit 110 may obtain the sensor transmission energy Et by applying a velocity v, which is a differential value with respect to the displacement of the anvil 138 that is measured by the laser displacement sensor, to the above equation. Of course, the laser displacement sensor may also measure displacement of the horn 136.

The laser displacement sensor may be coupled to at least one of the anvil 138 and the horn 136 or may be positioned to be spaced apart from the anvil 138 and the horn 136.

The eddy current sensor is a sensor that uses a change in inductance of a coil which is caused by eddy current generated in a conductive material, and the eddy current sensor measures the displacement of the vibrating anvil 138, and transmits the displacement of the anvil 138, as the sensor transmission information, to the welding quality measuring unit 110. The welding quality measuring unit 110 may obtain the sensor transmission energy Et by applying a velocity v, which is a differential value with respect to the displacement of the anvil 138 that is measured by the eddy current sensor, to the above equation.

Of course, the eddy current sensor may also measure the displacement of the horn 136, and transmit the displacement of the horn 136, as the sensor transmission information, to the welding quality measuring unit 110.

The eddy current sensor may also be coupled to at least one of the anvil 138 and the horn 136 or may be positioned to be spaced apart from the anvil 138 and the horn 136.

The device 100 for measuring welding quality according to the present disclosure is not limited by the sensor type and the coupling structure of the sensor unit 120. As the sensor unit according to the present disclosure, any sensor unit may be acceptable as long as the sensor unit may measure the acceleration, the velocity, or the displacement of at least one of the anvil 138 and the horn 136. The sensor unit according to the present disclosure may also be coupled to the horn 136 or may be positioned to be spaced apart from both of the horn 136 and the anvil 138.

The welding quality measuring unit 110 obtains the sensor transmission energy Et, through the aforementioned method, by using the sensor transmission information inputted through the sensor unit 120. In addition, the welding quality measuring unit 110 obtains the welder output energy Eo. The welding quality measuring unit 110 may obtain the welder output energy Eo by using drive electric current and voltage supplied to the controller 130 of the ultrasonic welding system.

In addition, the welding quality measuring unit 110 may obtain the welder output energy Eo by using electric current and voltage supplied to the vibrator 132 of the ultrasonic welding system.

The welding quality measuring unit 110 obtains the welder output energy Eo and the sensor transmission energy Et, and then calculates the welding absorbing energy Ew based on the following equation. The welding absorbing energy Ew may be energy actually absorbed by the workpieces 140 to be welded due to the ultrasonic welding.

Eo=Et+Ew

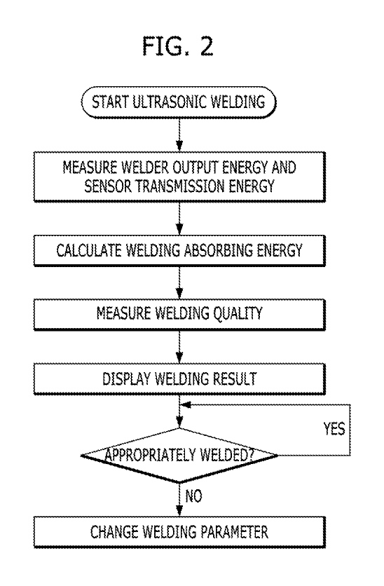

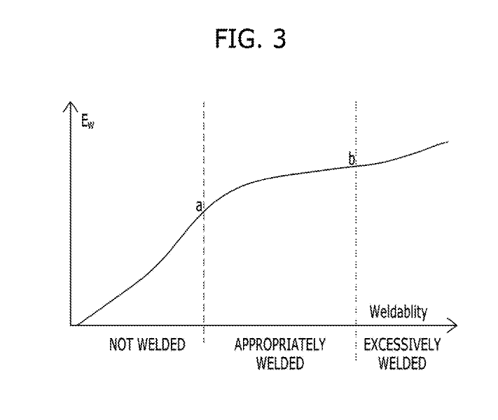

FIG. 2 is a flowchart illustrating a method for measuring quality of ultrasonic welding according to the exemplary embodiment of the present disclosure. FIG. 3 is a graph illustrating welding quality with respect to energy absorbed by a welded portion.

Referring to FIGS. 2 to 3, the method for measuring quality of ultrasonic welding according to the exemplary embodiment of the present disclosure includes measuring welder output energy and sensor transmission energy, calculating welding absorbing energy by using the welder output energy and the sensor transmission energy, measuring welding quality by using the welding absorbing energy, displaying welding result, determining whether the welding is appropriately performed, and changing a welding parameter when the welding is not appropriately performed.

The welding quality measuring unit 110 may obtain the welder output energy Eo and the sensor transmission energy Et, and then may calculate the welding absorbing energy Ew based on the above equation. Further, the welding quality measuring unit 110 determines one of whether the welding is not performed, whether the welding is appropriately performed, and whether the welding is excessively performed, as welding quality by using the calculated welding absorbing energy Ew.

The welding quality measuring unit 110 may store a data base regarding welding quality according to the welding absorbing energy Ew associated with a size, a shape, and a material of the workpiece to be welded or may use this information. Referring to FIG. 3, a range of the welding absorbing energy Ew associated with the appropriate welding is a to b, the welding quality measuring unit 110 may determine that the welding is not performed when the calculated welding absorbing energy Ew is below a, may determine that the welding is excessively performed when the welding absorbing energy Ew is above b. Of course, the calculated welding absorbing energy

Ew is within the range of a to b, the welding quality measuring unit 110 may determine that the welding is appropriately performed. The result of welding quality by the welding quality measuring unit 110 may be measured in real time.

The welding quality measuring unit 110 may display the measured welding quality through a display 112.

The welding quality measuring unit 110 may change the welding parameter in real time by using information about the measured welding quality. For example, based on the result of measuring the welding quality, at least one of pressing force and amplitude of vibration of the horn 136 with respect to the workpieces 140 to be welded may be increased when it is determined that the welding is not performed, and at least one of pressing force and amplitude of vibration of the horn 136 with respect to the workpieces 140 to be welded may be decreased when it is determined that the welding is excessively performed. The welding quality measuring unit 110 may additionally control at least one of frequency and time, as the welding parameter, in addition to the pressing force and the amplitude of vibration of the horn 136.

Since the device 100 for measuring welding quality according to the present exemplary embodiment obtains the welder output energy Eo and the sensor transmission energy Et, and then obtains the welding absorbing energy Ew by using the welder output energy Eo and the sensor transmission energy Et, it is possible to improving reliability in respect to the measurement of welding quality. In addition, since the device 100 for measuring welding quality according to the present exemplary embodiment may easily measure the welder output energy Eo and the welding absorbing energy Ew, it is possible to easily measure welding quality.

While the exemplary embodiments of the present disclosure have been described above, it may be understood by those skilled in the art that the present disclosure may be variously modified and changed without departing from the spirit and scope of the present disclosure disclosed in the claims.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A device for measuring quality of ultrasonic welding, the device comprising:
a sensor unit which provides sensor transmission information; and
a welding quality measuring unit which obtains welder output energy Eo, obtains sensor transmission energy Et by using the sensor transmission information, calculates welding absorbing energy Ew based on the following equation, and determines whether a welding defect occurs by using the welding absorbing energy Ew.
Eo=Et+Ew (Equation)

2. The device of claim 1, wherein the welding quality measuring unit determines that welding is not performed when the welding absorbing energy is below a predetermined value, and determines that welding is excessively performed when the welding absorbing energy is above a predetermined value.

3. The device of claim 1, wherein the sensor unit is an acceleration sensor coupled to an anvil.

4. The device of claim 1, wherein the sensor unit is a laser displacement sensor.

5. The device of claim 1, wherein the sensor unit is an eddy current sensor.

6. The device of claim 1, wherein the welding quality measuring unit obtains the welder output energy by using electric current and voltage supplied to a controller or a vibrator of an ultrasonic welding system.

7. A method for measuring quality of ultrasonic welding, the method comprising:
measuring welder output energy Eo and sensor transmission energy Et;
calculating welding absorbing energy Ew by using the welder output energy Eo and the sensor transmission energy Et based on the following equation; and
Eo=Et+Ew (Equation)
measuring welding quality by using the welding absorbing energy Ew.

8. The method of claim 7, wherein when it is determined that a defect occurs based on the result of measuring the welding quality, a welding parameter is controlled so that welding quality becomes appropriate welding.
